(19) United States
(12) Patent Application Publication
(10) Pub. No.: US 2006/0082494 A1
(43) Pub. Date: Apr. 20, 2006

(54) Method and system for sampling at least one antenna

(75) Inventors: Juergen Deininger, Weil der Stadt (DE); Bernd Gottschalk, Eningen (DE); Stefan Lindenmeier, Elchingen (DE); Guenter Reichert, Affalterback (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Epplestrasse (DE)

(21) Appl. No.: 10/505,160

(22) PCT Filed: Feb. 11, 2003
(86) PCT No.: PCT/EP03/01314

§ 371 Date: Sep. 30, 2005

(30) Foreign Application Priority Data
Feb. 22, 2002 (DE) 102 07 487.9

(51) Int. Cl. G01S 7/40

(52) U.S. Cl. 342/165; 342/173

(57) ABSTRACT

A method for testing at least one antenna having a receiver module and a coupling module which is arranged between the antenna and the receiver module. The antenna and the receiver module are supplied with a noise signal as a test signal by the coupling module. An instantaneous transmission coefficient, which indicates the ratio between a first noise signal (which is passed to the test module via a first path without passing through the at least one antenna) and a second noise signal (which is passed to the test module from the noise source via a second path which passes via the at least one antenna) being determined, and being compared with a reference transmission coefficient, which is stored in a transmission matrix, by a test module. An arrangement for carrying out the method is also provided.

### BACKGROUND AND SUMMARY OF THE INVENTION

The invention relates to a method and an arrangement for testing at least one antenna, in particular a multiple antenna system in a vehicle.

As the number of antennas on vehicles increases, it is becoming necessary to carry out a functional test of the antenna system. Functional tests such as these are normally carried out in the removed state. A functional test with the antenna in the installed state has been particularly complex and required a particularly large amount of effort. For example, DE 196 18 333 A1 describes a circuit arrangement for functional testing of mobile broadcast radio receiving systems in the installed state. One disadvantage of this circuit arrangement is that it has a calibrated signal generator to produce a test signal, which signal generator transmits a discrete test signal exclusively at the frequency to which the receiver is tuned. Furthermore, the circuit arrangement is not suitable for diagnosis which accounts for external influences, such as snow or ice.

A system for testing a signal transmitter/receiver, for example for a receiving antenna, is disclosed in U.S. Pat. No. 6,005,891. In this case, a pseudo-random noise signal source is used as the test signal source. A complex circuit is used in the system to process a signal which has been reflected from a damaged receiving antenna and to compare this with the original test signal. A correlation receiver, among other items, is required for this purpose. However, this system is highly costly to produce, as a result of the use of the pseudo-random noise signal source, which produces a high-speed digital signal, as well as the correlation receiver. Furthermore, it is always necessary to know the level of the output signal from the pseudo-random noise signal source.

The invention is thus based on a method for testing at least one antenna in a vehicle, in which diagnosis can be carried out at all the frequencies in one band, for example a radio, TV, mobile radio or ISM band, at low costs and in a particularly simple manner. Furthermore, the invention provides a particularly simple arrangement for testing the antenna in the installed state. In the invention knowing the level of the test signal source is not necessary, thus making it possible to use a low-cost test signal source.

The advantages which are achieved by the invention are, in particular, that a noise signal from an uncalibrated noise source is injected into the antenna as a test signal by means of a controllable coupling module. If there is only a single antenna, the noise signal which is being reflected at the antenna input is evaluated as the received signal in a test module. For this purpose, the received signal is advantageously used to determine an instantaneous transmission coefficient, which represents the relevant antenna, at a predetermined frequency or at two or more frequencies in a band. The instantaneous transmission coefficient is compared with a reference transmission coefficient, which represents the transmission behavior of the noise source via the coupling module to the antenna and back to the receiver. A serviceable antenna produces minimal reflection at the antenna.

In the case of a multiple antenna system comprising two or more antennas, the noise signal transmitted between the antennas is analyzed and assessed alternatively or in addition to the noise signal which has been reflected at the respective antenna inputs. For this purpose, the noise signal is injected into the antenna or antennas from the uncalibrated noise source or test signal source by means of a coupling circuit, is received by an adjacent antenna, and is analyzed by means of a transmission matrix in the test module, in particular in the receiver, for example an audio or video tuner. Such functional monitoring or diagnosis using a simple uncalibrated noise source, which in the simplest case is formed by a source in the receiver itself, allows a particularly low-cost and simple arrangement. In particular, the production cost is particularly low. As a result of the use of already existing components in the receiver, the arrangement generally requires little space and, as a result of this and due to the integration of the test module, for example, in a vehicle, there is no need for complex test transmitters at the end of the production line or for servicing when the diagnosis or test method is used in the vehicle field.

Furthermore, the use of a noise signal as the test signal allows a diagnosis covering all the frequency bands to be carried out on the antenna or antennas. In particular, a test such as this based on a noise signal also allows evaluation relating to external influences on the serviceability of the antenna or antennas, such as snow or other external interference signals, which lead to incorrect diagnosis in the case of the conventional systems based on the prior art. In particular, this ensures that the antenna or antennas is or are tested and monitored in the installed state as well, and thus, for example, while a vehicle is being driven.

### BRIEF DESCRIPTION OF THE DRAWINGS

Preferred exemplary embodiments of the invention will be explained in more detail in the following text in conjunction with the drawing, in which:

FIG. 1 shows, schematically, a circuit arrangement for testing the serviceability of a multiple antenna system,

FIG. 2 shows, schematically, the signal waveform of a test signal in the multiple antenna system,

FIGS. 3 to 5 show, schematically alternative embodiments of the circuit arrangement as shown in FIG. 1, with switchable transmission paths for an AM band and an FM band, and an FM band with diversity,

FIG. 6 shows, schematically, a flowchart of the test method, and

FIGS. 7 to 14 show, schematically, various circuit arrangements for testing the serviceability of an individual antenna.

Mutually corresponding parts are provided with the same reference symbols in all of the figures.

### DETAILED DESCRIPTION

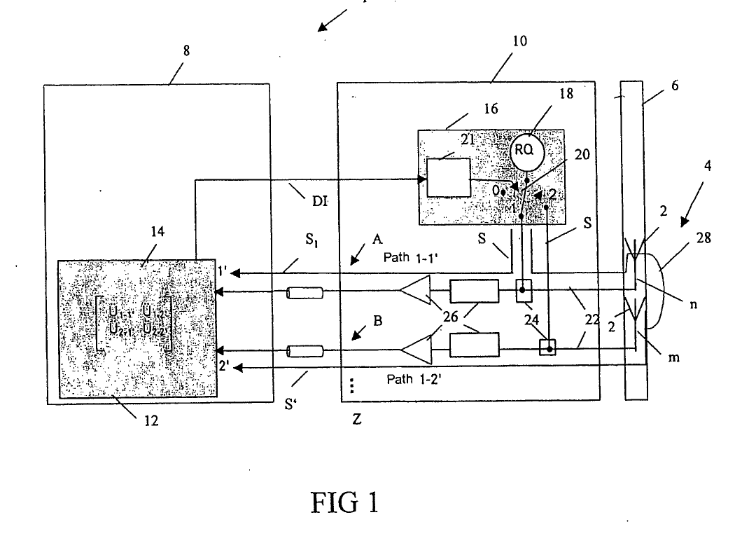

FIG. 1 shows a circuit arrangement 1 for testing an antenna system 4, which comprises two or more antennas 2, on a vehicle. The antenna system 4 is integrated in a glass pane 6, for example the rear windshield, a side window, or the rear window and/or side window or windows of the vehicle. The circuit arrangement 1 has a receiver module 8 and a coupling module 10, which is arranged between the antennas 2 and the receiver module 8. The antenna or coupling module 10 is used for injection of a noise signal S into the respective antenna 2 and into the receiver module 8, which is also referred to as a tuner. The receiver module 8 also has a test module 12 for determination of an instantaneous transmission coefficient (Üᵥᵢ) on the basis of the ratio between the noise signal component S′ that is injected via the antennas, and the noise signal component S1 which is transmitted directly from the noise source to the receiver. In order to determine the serviceability of the respective antenna 2, the test module 12 has a transmission matrix 14 in which a reference transmission coefficient (Üᵥᵢₙₒᵣₘ) (also referred to as (Üᵥₙ₋ₘ)) is stored for the respective antenna 2, describing the transmission response and/or transmission path. The serviceability of the antenna 2 is deduced from a comparison of the instantaneous transmission coefficient (Üᵥᵢ) with the reference transmission coefficient (Üᵥᵢₙₒᵣₘ). The coupling module 10, which is also referred to as an antenna module, has, as a diagnosis circuit 16, an uncalibrated noise source 18 and an RF switch 20 which can be driven. The noise source 18 in this case covers all the frequency bands which can be detected in the receiver module 8.

In one advantageous embodiment, the noise source 18 may be in the form of a bipolar transistor in an amplifier circuit. With the diagnosis or test method proposed here, there is no need for a calibrated noise source. This makes it possible to avoid the complex determination of the instantaneous frequency response of the noise source 18, which is dependent on components and temperature. The RF switch 20 which can be driven is, for example, in the form of switching diodes. The number of switching diodes corresponds to the number of antennas 2 which are used as transmitting antennas 2(n) in the diagnosis mode. The number of transmitting antennas 2(n) used governs the evaluation confidence of the diagnosis.

The diagnosis circuit does not involve expensive production costs but can, for example, be accommodated on the board surface of the antenna amplifier module, by changing its layout. The data can be evaluated in the tuner or receiver 8 by an addition to the software, and there is no need for additional hardware. Depending on the nature and embodiment of the circuit arrangement 1, the receiver module 8 and the coupling module 10 may be formed by a common module. Furthermore, the individual modules may be in the form of software and/or hardware, depending on the function. In addition, the arrangement and combination of the individual modules may vary, depending on the requirement.

The switching diodes are driven by means of a digital counter 21. If the bit rate is low, a control signal DI transmits two voltage states from the receiver module 8 to the digital counter 21. The control signal DI can be transmitted along an already existing RF cable in the same way as is already done for driving a given FM diversity circuit. The counter 21 is switched onwards by one position on each positive edge of the control signal DI, so that all of the antenna branches A, B, . . . , Z are switched through successively. Once the final antenna branch Z has been switched through and the diagnosis is produced, the next positive edge causes the noise source 18 to be switched off or, alternatively, to be switched to a state in which no antenna branch A to Z is switched through. The next positive edge once again switches the first antenna branch A through in a new diagnosis cycle.

At least two rear windshield antennas 2 are successively connected as transmitting antennas 2(n) via the RF switch 20. In an antenna system 4 having at least two antennas 2, the serviceability of the antennas 2 is preferably measured by measurement of the near field transmission between the antennas 2. The reference transmission coefficients Üᵥᵢₙₒᵣₘ or factors for all the possible couplings between the antennas 2 form the transmission matrix 14. The instantaneous transmission coefficients Üᵥᵢ are determined analogously to this on the basis of the transmission matrix 14, and are compared with the reference transmission coefficients Üᵥᵢₙₒᵣₘ. In this case, the antennas 2 are used both as transmitting antennas and as receiving antennas.

The transmission path is determined by transmission of the noise signal S via one of the antennas 2 as a transmitting antenna n and by reception of the received signal S′, which results from this, at one of the other antennas 2 as a receiving antenna m, and by reflection of the noise signal S at the antenna input of the relevant transmitting antenna n.

The evaluation on the basis of the transmission matrix 14 expediently allows identification of adverse affects, such as wetness, snow, external interference signals, which can affect two or more antennas 2. The test or diagnosis is carried out such that the transmission of the noise signal S from the respectively selected transmitting antenna 2(n) to the other adjacent rear windshield antennas 2, which form the receiving antennas 2(m), is tested in the receiver module 8, in particular for all frequency bands. Each antenna 2 is thus tested for its transmission behavior Üᵥ in a number of frequency bands. The FM band, the highest TV band and the AM band are expediently analyzed, so that the operation of the antennas 2 can be tested and determined reliably and easily on the basis of the transmission behavior Üᵥ. Since the transmission is further tested in different combinations of transmitting antennas n and receiving antennas m, it is possible to exclude external fault sources.

During operation of the circuit arrangement 1, the RF switch 20 does not allow any noise signal S on the antenna path 22 during normal antenna operation, when it is in the position 0. In the diagnosis or test mode, the RF switch 20 is switched successively to the positions 1 and 2, with the noise signal S being injected successively in to the antenna path 22 via coupling circuits 24, for example by means of T junctions or capacitively. There, the noise signal S is split into the noise signal S1, which is passed directly from the noise source 18 to the tuner 8, and the noise signal S2, which migrates to the relevant antenna 2 and is emitted at the antenna 2. Statements relating to the serviceability of the relevant antennas 2 can be made from the comparison of the received signal S2, which is received from the receiving antenna 2(m), with the noise signal S1, which is supplied directly for level evaluation. Furthermore, depending on the extent of the analysis, amplifier and filter circuits 26 which affect the transmission path and their influence on the transmission can be taken into account. Since two or more or all of the antennas 2 are used as transmitting antennas n, and all of the antennas 2 are used as receiving antennas m, the entire system can be represented by a transmission matrix 14 with a maximum size of n×m.

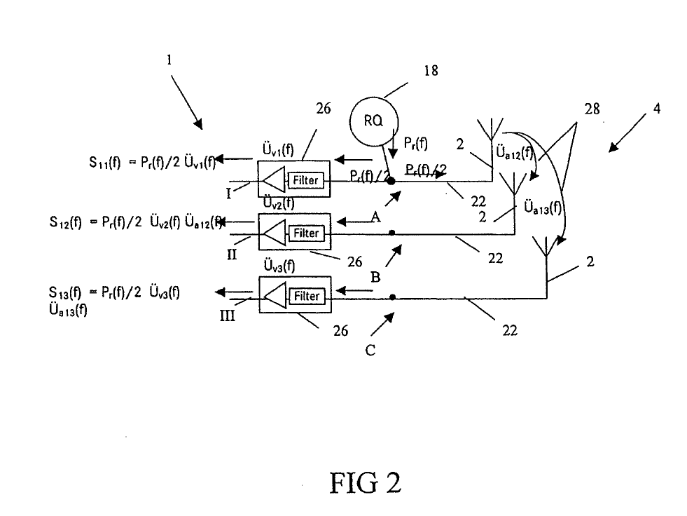

The determination of the transmission matrix 14 for a level evaluation and the measurement tolerance to be expected will be described in the following text with reference to FIG. 2. This is based on the assumption, by way of example, of a multiple antenna system 4 with three antennas 2. However, the principle also applies to other systems 4 which have at least two antennas 2.

For level evaluation using the transmission matrix 14, the signal levels Si1, Si2 and Si3 are respectively detected at the ports I, II and III for level evaluation when two or more antennas i (i=1, 2, 3) are used as the transmitting antenna n. In the case of an antenna system 4 which is largely completely serviceable, that is to say it is optimally matched, minimal reflection occurs at the antenna inputs 2. The noise signal S whose level is Pr(f) is injected successively into each of the signal paths 22 of the antennas 2. Some of the noise power is emitted via the respectively connected antenna 2, while a further portion is passed via the respective filter amplifier circuit 26 in the path 22 directly to the receiver module 8. The level Pr(f) of the noise source 18 need not be known in advance before measurement, since it can be determined from the measurement evaluation by means of the test module 12 in the receiver module 8. The measurement results in the diagnosis process are thus not dependent on the tolerance of the noise source 18.

The assumed transmission coefficient or reference transmission coefficient Üᵥᵢₙₒᵣₘ(f), the filter amplifier circuit 26 with the narrowest tolerance δvi and the actual transmission coefficient on the basis of
Üᵥᵢ(f) where Üᵥᵢ(f)=Üᵥᵢₙₒᵣₘ(f)×(1+δᵥᵢ(f)) [1]
are used as the basis for determination of the instantaneous noise power Pᵣ.

The signal level S11, as detected in the level evaluation, for the first antenna 2 at the port I in accordance with
S₁₁(f)=(Pᵣ(f)/2)×Üᵥ₁(f)=(Pr(f)/2)×Üᵥ₁ₙₒᵣₘ(f)×(1+δᵥ₁(f)) [2]
is used as the basis for determination of the noise level Pᵣ(f) for a given measurement tolerance δᵥ:
Pr(f)=2S₁₁(f)/((Üᵥ₁ₙₒᵣₘ(f))×(1+δᵥ₁(f)) [3]

Accordingly, the noise characteristics of the noise source 18 may differ individually for each component, may be dependent on the temperature, and need not be known in advance. This allows simple low-cost noise sources 18 to be produced. Once the noise level Pr(f) has been determined, the transmission coefficients Üᵥ₂(f) and Üᵥ₃(f) of the other filter amplifier circuits 26 can be determined from the respective signal levels S22 and S33.
Üᵥ₂(f)=2S₂₂(f)/Pᵣ(f); Üᵥ₃(f)=2S₃₃(f)/Pᵣ(f) [4]

By comparison with the reference transmission coefficients Üᵥ₂ₙₒᵣₘ(f) and Üᵥ₃ₙₒᵣₘ(f) or nominal values for the respective frequency bands, the serviceability of the respective filter amplifier circuit 26 can easily be deduced from these coefficients Üᵥ₂(f) and Üᵥ₃(f). The tolerance δv for the noise power Pr is also obtained from these coefficients Üᵥ₂(f) and Üᵥ₃(f). The transmission coefficients Üₐ₁₂(f) and Üₐ₁₃(f) between the antennas 2 make it possible to calibrate out the tolerances in the transmission path 28 on the basis that:
Üₐ₁₂(f)=S₁₂(f)/S₂₂(f); Üₐ₁₃(f)=S₁₃(f)/S₃₃(f) [5]

The indication tolerance in the receiver 8 is not included in this analysis, since the assessment of the antenna system 4 always relates to its sensitivity. Accordingly, if the sensitivity of the receiver 8 is high, the antenna system 4 may have correspondingly poorer transmission characteristics. The required quality of the antenna system 4 is thus always assessed as a function of the available tuner sensitivity using the diagnosis system or the circuit arrangement 1, so that entire systems 1 (receiver 8 and antenna system 4) with the same quality are always assessed to be the same.

The transmission coefficients Üₐ not only provide information about the serviceability of the antennas 2, but also about the extent to which the transmission path 28 between the antennas 2 is subject to interference. If, for example, the antennas 2 are covered with snow, then all of the transmission coefficients Üᵥᵢ(f) are interfered with to the same extent, and the diagnosis algorithm identifies that it is not an antenna 2 which is faulty, but that all the transmission paths 28 are affected. The state of the antennas 2, for example the fact that the rear windshield 6 is covered with a foreign body, is deduced as a function of the magnitude of the instantaneous determined transmission coefficients Üᵥᵢ(f).

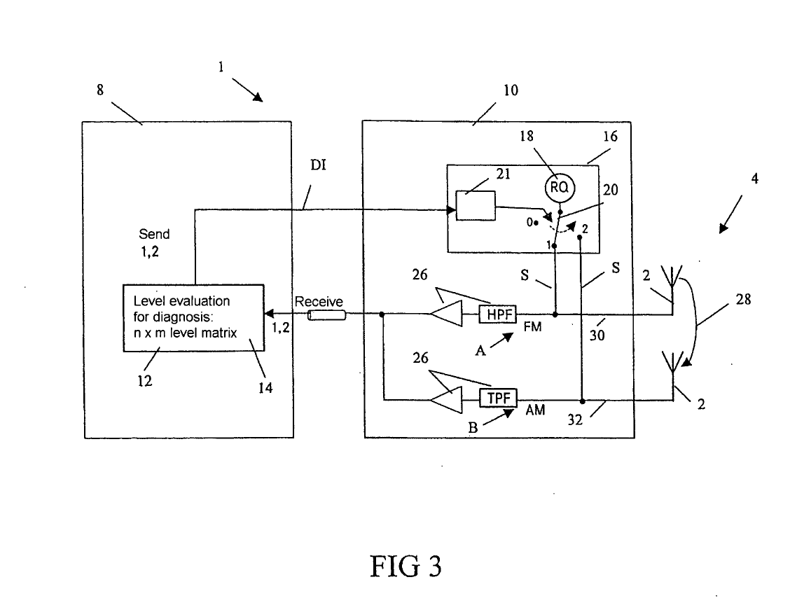

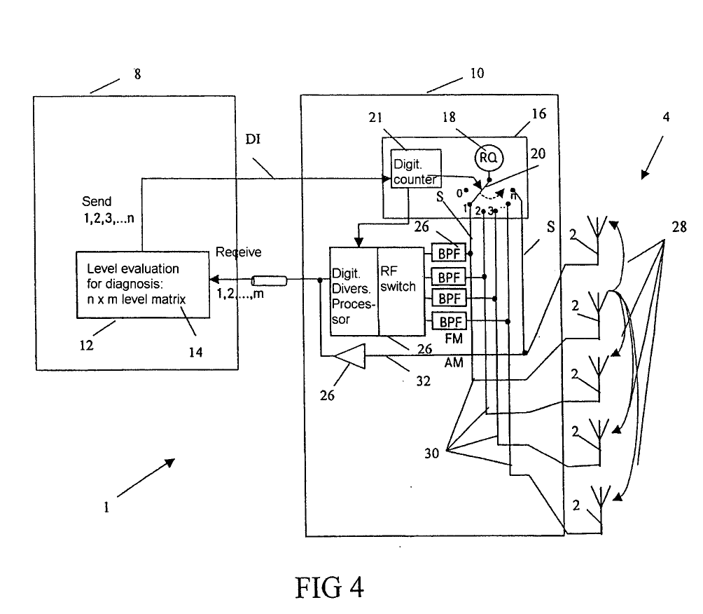

FIG. 3 shows an alternative embodiment of the circuit arrangement 1, in which, in order to test the various frequency bands of the receiver module 8, the coupling module 16 is intended to inject the noise signal S into the relevant transmission branch 30 or 32 for the FM band or AM band, respectively, using the positions 1 and 2 of the RF switch 20. The circuit arrangement 1 in this embodiment has a two-antenna system 4 for the AM and FM bands. FIG. 4 shows a further embodiment of the circuit arrangement 1 for a five-antenna system 4 for the AM band and the FM band, with quadruple diversity. The number of positions of the RF switch 20 must be increased by the appropriate number of antennas in order to test the FM band with diversity. The test procedure is carried out as already described above. Accordingly, the noise signal S from the noise sourse 18 is injected separately into each antenna 2 by means of the RF switch 20. Relevant transmission coefficients Üᵥᵢ(f) are determined for all possible combinations of the antennas 2 on the basis of the respective received signal S′, which is received by means of one of the adjacent antennas 2, and the transmitted noise signal S, and is compared with the reference transmission coefficients Üᵥᵢₙₒᵣₘ(f) for the transmission matrix 14.

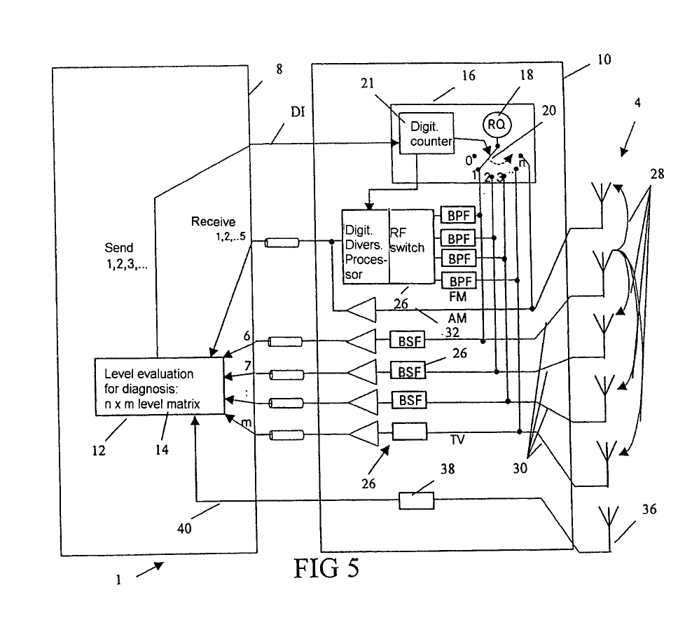

The method described above for testing the serviceability of the antenna 2 is not dependent on the antenna type. FIG. 5 shows one embodiment for a further diagnosis circuit for a five-antenna system 4, for a so-called high-end version for AM, FM and TV diversity. As is illustrated in FIG. 5, it is also, by way of example, possible to investigate an FZV antenna 36 (FZV=radio central locking) on the basis of the method described above, if the associated FZV receiver 38 is connected to the AM/FM tuner 8 via a data line 40, so that information about the received level is transmitted to the AM/FM receiver 8 for evaluation.

Alternatively or additionally, depending on the equipment fitted to the vehicle, it is also possible to investigate the serviceability of mobile telephone and/or GPS antennas via broadband coupling to TV, AM and FM antennas. In this case, it is irrelevant where and how the individual antennas 2 are integrated in the vehicle.

During operation of the circuit arrangement 1, as shown in one of the FIGS. 1 to 5, the total of n antennas 2 are successively connected as transmitting antennas. Depending on the number n of transmitting antennas 2, this results in a corresponding number m of receiving antennas 2, and thus in n×m level information items, which are preferably in the form of a level or transmission matrix 14, in order to represent the transmission behavior Üᵥ. A permissible value range can be produced for each transmission coefficient Üᵥᵢ in the transmission matrix 14, which:
1. is individually associated with the coupling of in each case one antenna pair 2(n, m), and
2. is dependent on all of the instantaneous measured transmission coefficients Üᵥᵢ in the transmission matrix 14.

If a permissible value range is exceeded, one or more antennas 2 is or are determined to be defective on the basis of the transmission matrix 14.

External interference effects, which affect one or more antennas 2, for example ice on the rear windshield 6, are advantageously analyzed and identified in the diagnosis process by dynamically matching the value ranges to the instantaneous reception situation.

Table 1, below, shows one example of a transmission matrix 14 for an antenna system 4 with four antennas 2.

TABLE 1

| TX/RX | Ant 1 | Ant 2 | Ant 3 | Ant 4 | Ant m |
|---|---|---|---|---|---|
| Ant 1 | P11 | P12 | P13 | P14 | . |
| Ant 2 | P21 | P22 | P23 | P24 | . |
| Ant 3 | P31 | P32 | P33 | P34 | . |
| Ant 4 | P41 | P42 | P43 | P44 | . |
| Ant n | . | . | . | . | Pnm |

where Ant n=the number of transmitting antennas, Ant m=the number of receiving antennas, TX=a transmitter, RX=a receiver, Pnm=the signal level.

Depending on the nature and the function of the circuit arrangement 1, the transmission matrix 14 has, as information items, level and/or frequency values which represent the reference transmission coefficients Üᵥᵢₙₒᵣₘ and/or instantaneous transmission coefficients Üᵥᵢ for the relevant antenna combination. During a diagnosis, the instantaneous transmission coefficients Üᵥᵢ are compared with the reference transmission coefficients Üᵥᵢₙₒᵣₘ for each of the antenna combinations 2(n, m). To do this, the transmission matrix 14 must be initialized, for example before initial use of the vehicle, such as at the time of production. Reference knowledge is generated for this purpose, on the basis of which a diagnosis can then take place. One possible method for knowledge generation and evaluation is described in the following text.

A diagnosis is carried out in a number of steps:
I) symptom generation
(for example on the basis of the available information in the transmission matrix 14)
II) fault identification
III) fault localization

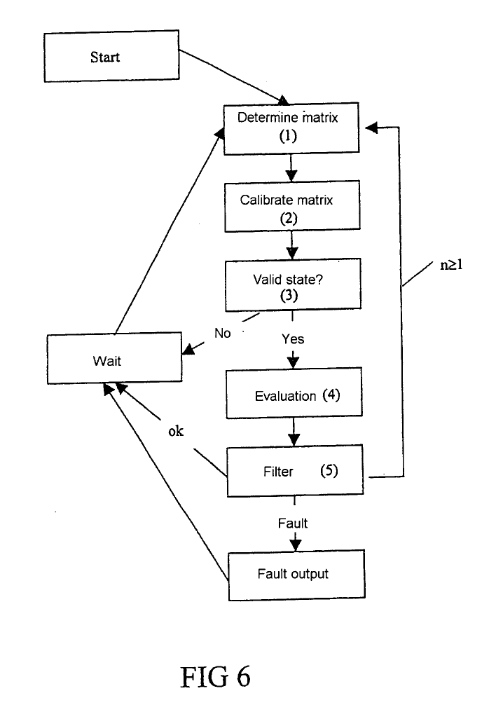

By way of example, FIG. 6 shows a flowchart for the diagnosis method, comprising the following steps:
(1) Recording of the matrix elements, for example on the basis of measurements, presetting type-specific values or reading stored previous values;
(2) Calibration by normalization of the matrix elements with respect to the transmission power and transmission losses. The calibration is carried out on the basis of the element on the diagonal of the transmission matrix 14.
(3) Identification of “invalid states”, such as an icy rear windshield or an electromagnetic field which is subject to severe interference.
(4) Evaluation by comparison with stored fault situations or by means of a decision network. Alternatively or additionally, a fault in one or more of the antennas 2 or antenna combinations 2(n, m) can be identified on the basis of a frequency analysis or amplitude analysis.
(5) Filtering, plausibility check, that is to say the diagnosis process is carried out n-times. Depending on the requirement, a fault message is emitted only after a fault situation has been successfully detected n-times, otherwise no message is produced or a “healthy” message is emitted, that is to say the fault memory is reset when the satisfactory state is identified two or more times.

The measurement and diagnosis method will be explained in the following text with a reference to an example. The transmission behavior between different rear windshield antennas 2 in their near field is determined by means of a so-called network analyzer. The transmission behavior is measured by injecting the noise signal S into the antennas 2 successively. The vehicle roof, the C pillars and the rear cover with sheet steel parts electrically connected has been modeled in order to estimate the field behavior on the actual vehicle. Measurements have been carried out for intact antennas 2 as well as for defective antennas 2, for example for a discontinuity in the windowpane contacts and/or for a discontinuity in the antenna wires on the rear windshield 6. The influence of wetness on the transmission behavior has also been measured.

The transmission or noise signal S was injected directly into the antenna 2, with the antenna amplifier disconnected. The transmitting antenna 2 is thus not matched. If the transmitting antenna 2 is fed in a matched manner, the transmission factors are better. The values included in the following tables are the S21 transmission coefficients in dB, in each case measured at 100 MHz (FM). S21 transmission coefficients represent the transmission factor or transmission coefficients Üᵥᵢ between the respective antennas 2 which are coupled via the near field. In addition to the normal situation in which the antennas 2 are serviceable, a number of types of fault situations, and their influence on the transmission factors, have been investigated. The fault situations were brought about by disconnecting the windowpane contacts, interrupting the windowpane antenna wires, influencing the near field of the antennas 2 by means of water on the windowpane, and by means of metal surfaces located in the near field of the antennas 2.

For the normal situation without any fault influence on an antenna system 4 which comprises six antennas 2 and is integrated in the rear windshield 6, the transmission matrix illustrated in Table 2 is obtained for the frequency f=100 MHz (FM band):

TABLE 2

| | FM1/ | | | | | |
|---|---|---|---|---|---|---|
| dB | TV1 | FM2/TV2 | TV3 | FM4/TV4 | AM | FZV |
| FM1/TV1 | X | −25.21 | −22.37 | −19.25 | −22.17 | −24.76 |
| FM2/TV2 | | X | −9.195 | −22.51 | −8.053 | −5.906 |
| TV3 | | | X | | −14.56 | −19.12 |
| FM4/TV4 | | | | X | −23.38 | −23.74 |
| AM | | | | | X | −2.456 |
| FZV | | | | | | X |

The instantaneous transmission coefficients Üᵥᵢ determined by means of the transmission matrix 14 are all better than −25 dB and the required transmission powers to be expected for near field transmission are very low, measured with respect to the conventional far field transmission/reception situation.

In order to illustrate the detection of poor contacts with the antenna 2, the window pane contacts were made worse or were interrupted at the connections to the antennas FM1 and TV3 by the insertion of layers of paper of different thickness. As is shown in Table 2, the antenna combination FM1 and TV3 normally has a transmission coefficient Üᵥᵢ of −22.37 dB.

Table 3 shows the influence of poor contacts on the transmission behavior in the form of a significant change in the transmission coefficients Üᵥᵢ determined in this instance by means of the transmission matrix 14.

TABLE 3

| Fault situations | S_{TV3→FM1} in dB for 100 MHz |
|---|---|
| Normal situation | −22.37 |
| 1 leaf on FM1 | −25.26 |
| 1 leaf on TV3 | −41.29 |
| 20 leaves on FM1 | −41.03 |
| 20 leaves on TV3 | −61.19 |
| 20 leaves on both FM1 and TV3 | −67.41 |
| Metal sheet in front of the | −19.42 |
| windowpane | |

The final fault situation “metal sheet in front of the windowpane” in this case simulates an invalid state, as would occur, for example, as a result of conductive material such as ice or water on the rear windshield 6.

Furthermore, a discontinuity in the antenna wires as modeled, for example by cutting through the conductor track for the antenna TV3 or cutting through both conductor tracks for the antennas TV3 and FM2. In this case, the test or noise signal S is transmitted via the antenna FM2 or FM1, depending on the drive for the coupling or RF switch 20. The transmission coefficients Ü determined by means of the transmission matrix 14 are shown in the following Tables 4A to 4C.

TABLE 4A

| FM2 → TV3 (dB) | 100 MHz | 800 MHz |
|---|---|---|
| Normal situation | −9.195 | −32.10 |
| Fault on antenna TV3 | −8.620 | −38.50 |
| Fault on antenna TV3 | −13.53 | −29.43 |
| and FM2 | | |

TABLE 4B

| FM1 → FM2 (dB) | 100 MHz | 800 MHz |
|---|---|---|
| Normal situation | −25.21 | −37.81 |
| Fault on antenna FM2 | −32.57 | −27.03 |

TABLE 4C

| FM2 → FM4 (dB) | 100 MHz | 800 MHz |
|---|---|---|
| Normal situation | −22.51 | −33.23 |
| Fault on antenna FM2 | −32.07 | −28.70 |

All the fault situations can clearly be identified from a decrease or increase in the transmission factors Ü. The method described above thus allows the serviceability of individual antennas 2 to be diagnosed particularly easily and reliably. Further transmission characteristics or operating parameters may be taken into account, depending on the type of antenna. For example, the rise in the so-called cross-coupling factor S FM1→FM3 in the UHF band (800 MHz) in the event of a fault in the FM antenna can be explained by shortening of the electrically effective antenna length. In contrast, the same fault in the FM band leads to a corresponding reduction in the coupling.

In a further test of the antennas 2, they are analyzed for changes caused by the influence of water on the rear windshield 6, or by other objects in the vicinity of the rear windshield 6. As is shown in the Tables 5A and 5B, water spray has virtually no influence on the transmission behavior at 100 MHz. In contrast, if objects, in particular conductive objects, are arranged closely in front of the rear windshield 6, these changes are indicated in the diagnosis, since they represent a significant influence on the transmission behavior of individual antenna pairs.

TABLE 5A

| FM2 → FM4 (dB) | 100 MHz | 800 MHz |
|---|---|---|
| Normal situation | −22.51 | −33.23 |
| Metal sheet in front of | −30.23 | −29.20 |
| the windowpane | | |
| Wet windowpane | −22.09 | −26.91 |

TABLE 5B

| FM2 → TV3 (dB) | 100 MHz | 800 MHz |
|---|---|---|
| Normal situation | −9.195 | −28.50 |
| Metal sheet in front of | −9.159 | −29.00 |
| the windowpane | | |
| Thick plastic film on | −8.330 | −30.45 |
| the windowpane | | |

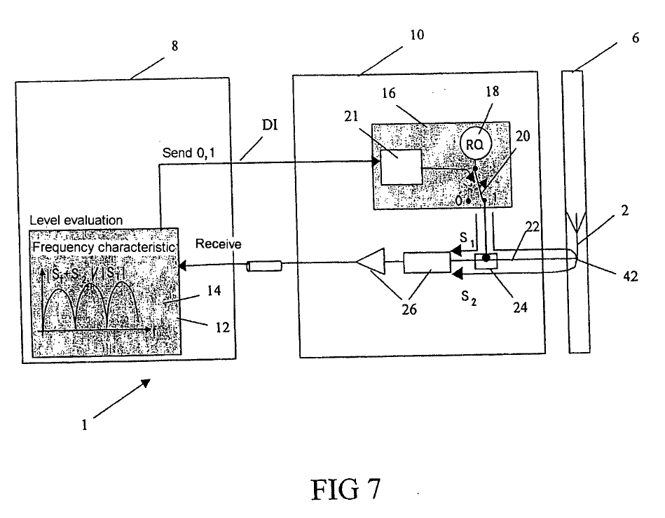

FIG. 7 illustrates an alternative embodiment of the circuit arrangement 1. The circuit arrangement 1 is designed for a single antenna system 4. In this case, instead of evaluating the noise signal S which is transmitted from the transmitting antenna to the receiving antenna 2, a noise signal S₂ which has been reflected at the relevant antenna input 42 of the single antenna 2 is analyzed and assessed on the basis of the transmitted noise signal S₁. Since any damage to the antenna 2 adversely affects its matching, reflections are produced at its input 42. When the RF switch 20 is in the position 0, it does not allow any noise signal S to pass from the noise source 18 to the antenna path 22 during normal antenna operation. RF switch 20 is in the position 1 in the diagnosis mode. The noise signal S is then coupled via a coupling network 24, for example a T element, into the antenna path 22, where the noise signal S is split into the noise signal S₁, which is passed directly from the noise source 18 to the receiver module 8, and the noise signal S₂, which migrates to the antenna 2 and is reflected at the antenna 2.

The superimposition of the noise signals S₁ and S₂, comprising the noise signal S₁ that is passed directly from the noise source 18 to the receiver 8, and the reflected noise signal S₂, results in a characteristic frequency characteristic with notches, from which conclusions are drawn about the state of the antenna 2, and these are assessed. However, this is dependent on a calibrated noise source 18, whose frequency characteristic is known. The serviceability of the antennas 2 can be determined only by comparison of the frequency characteristic of the superimposition of the noise signals S₁ and S₂ with the frequency characteristic of the noise signal S₁.

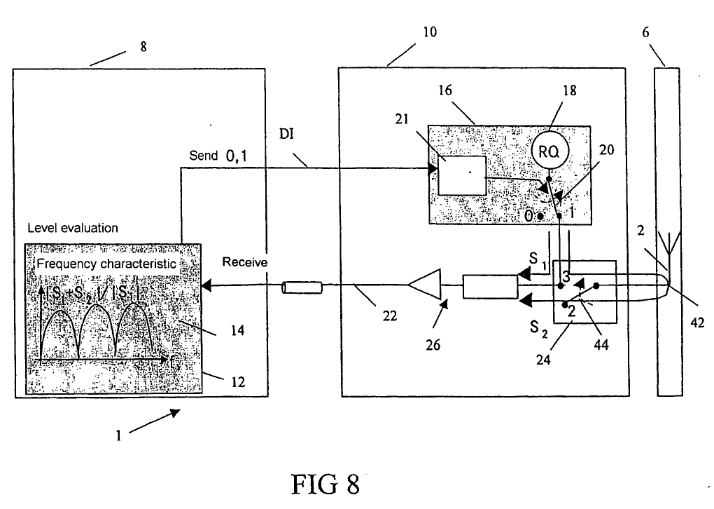

In order to allow the calibrated noise source 18 to be replaced by a lower-cost uncalibrated noise source 18, the static coupling circuit 24 has a switching function added to it, with additional positions 2 and 3 for the switchable coupling circuit 44, as is illustrated in FIG. 8. In the switch position 2, the noise signal S1 is passed directly to the receiver 8, where it is detected. This means that the antenna path 22 is open. The frequency characteristic of the instantaneous noise signal S1 is then known and is stored for level evaluation. The position 3 is then selected by means of the switchable coupling circuit 44, so that the antenna path 22 is closed. The frequency characteristic of the superimposition of the noise signals S1 and S2 is now detected in the level evaluation on the basis of the transmission matrix 14, and is compared with the frequency characteristic of the stored noise signal S1.

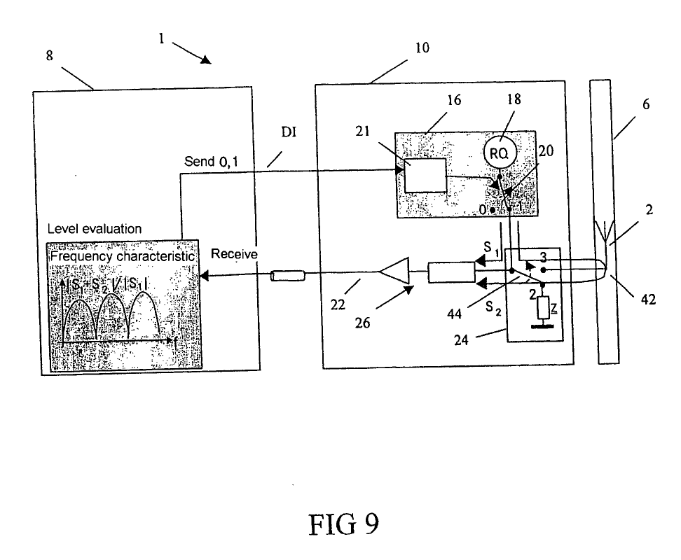

As an alternative to the switchable coupling circuit 44 or to the open switch, a superimposition of the noise signal S1 and of the noise signal S2 as reflected on a defined impedance Z can also be measured and analyzed for the reference measurement of the noise signal S1, with a calculation then being carried out back to the frequency characteristic of the pure noise signal S. The associated circuit arrangement 1 is illustrated, by way of example, in FIG. 9.

The frequency characteristic of the illustrated embodiments in FIGS. 7 to 9 for single antenna systems 4 is detected and analyzed in a relatively wide frequency band, in order to ensure statements that are as good as possible about the serviceability of the antenna 2, since significant level changes do not necessarily occur in the area of the mid-frequency fm in the superimposed noise signal S1+S2 if the antenna 2 is damaged.

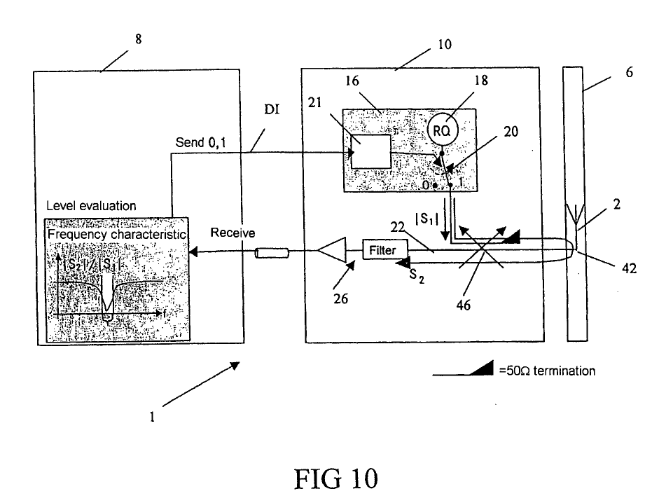

A directional coupling circuit 46, for example a directional coupler, as is illustrated in FIG. 10, is preferably used in order to allow the serviceability of the antenna 2 to be deduced just from the level changes of the reflected signal S2 when a narrow frequency band f is analyzed. In this case, only the reflected signal S2 is detected, whose level is considerably lower than the noise signal S1 if the antenna 2 is functioning. The level evaluation is in this case dependent on the noise signal level S1 already being known. This embodiment requires a calibrated noise source 18.

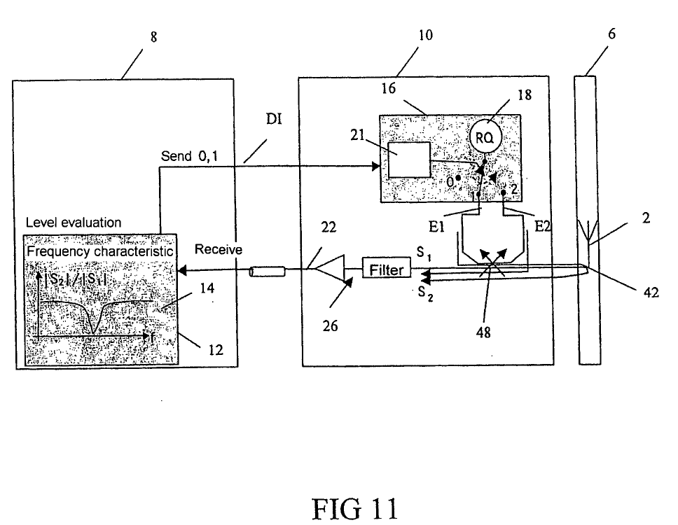

In order to allow a low-cost uncalibrated noise source 18 to be used, a directional coupling network 48 with a switchable signal flow direction is used, as is illustrated in FIG. 11. By way of example, a directional coupler with alternatively switchable inputs E1, E2 is provided for this purpose. In the switch position 1, the noise signal S is passed via the directional coupler 48 to the antenna 2, is reflected and is detected as a signal S2 in the level evaluation. In the switch position 2, the noise signal S is passed via the directional coupler 48 directly to the level evaluation, where it is detected as a reference signal S1.

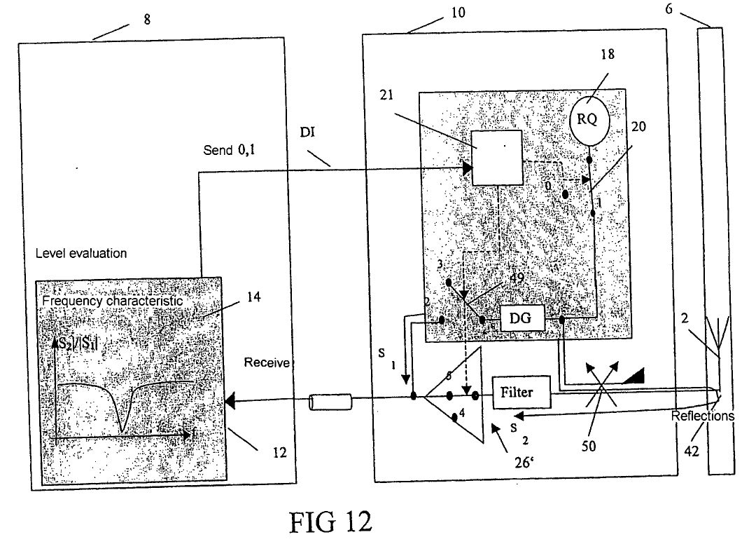

FIGS. 12 to 14 now show modified forms of the arrangement shown in FIG. 11, in which diagnosis is likewise possible using an uncalibrated, low-cost noise source 18. In this case, uncalibrated always means that the transmission power of the noise source is not known, and it need not assume reproducible values so that, for example, a major temperature drift in the transmission power is permissible. Only the design and function differences in comparison to FIG. 11 will be explained in more detail for these embodiments in the following text.

The embodiment shown in FIG. 12 uses a directional coupling network 50 with a switchable signal flow direction, in order to make it possible to use a low-cost uncalibrated noise source. A directional coupler with alternatively switchable inputs is likewise used in this case, as in the embodiment shown in FIG. 11 and in the embodiment shown in FIG. 12. However, in contrast to FIG. 11, one input is terminated with a 50 Ω impedance. In addition, the embodiment shown in FIG. 12, in contrast to the embodiment shown in FIG. 11, has a modified filter amplifier circuit 26′ with a switchable amplifier. Furthermore, a switch 49 is also provided and is used in conjunction with the switchable amplifier for switching from the signal path from the noise source 18 via the antenna 2 to the receiver 8 to the signal path from the noise source 18 directly to the receiver 8, and vice versa. In the switch position 2, the noise signal S from the noise source 18 is passed via the directional coupler 50 directly to the level evaluation, where it is detected as a reference signal S1, in order to make it possible to determine and calibrate out the noise level. For direct measurement of the noise signal S, the switchable amplifier 26′ is switched off, that is to say it is switched to the switch position 4, in order to interrupt the signal path via the antenna 2 to the receiver 8. In addition, an attenuator DG can be inserted into the path, to provide any required level reduction. In the switch positions 3 and 5, the noise signal S is passed to the antenna 2, where it is reflected and is passed via the modified filter circuit 26′ in the antenna module 10 to the receiver 8, in which it is detected in the level evaluation as a signal S2. The operation of the modified filter circuit 26′ can thus also be checked, in addition to that of the antenna 2. When the RF switch 20 is in the switch position 0, the noise source 18 is switched off, for normal operation.

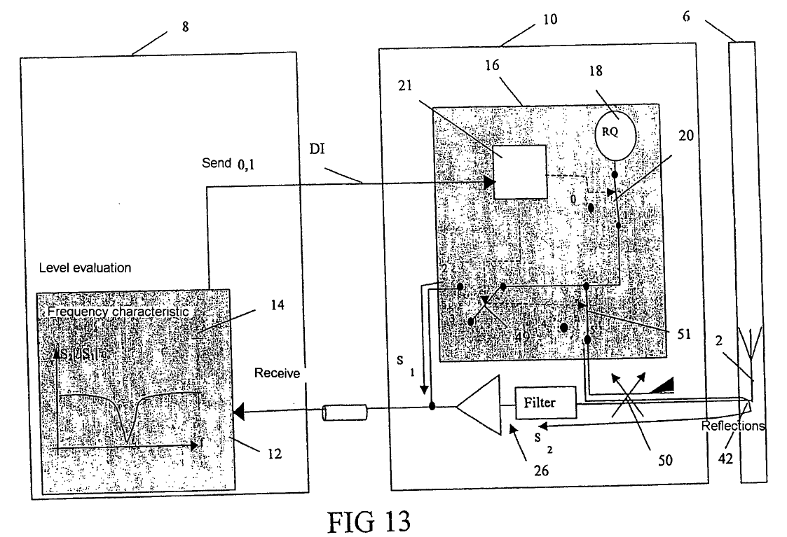

FIG. 13 shows a modified form of the embodiment shown in FIG. 12, which can be used when it is not possible to use the modified filter circuit 26′ with a switchable amplifier, but only the filter circuit shown in FIG. 11. In this case, an additional switch 51 with switch positions 4′ and 5′ is provided, by means of which the switch positions 4 and 5, which are provided in the switchable amplifier in the modified filter circuit 26′ in FIG. 12, are replaced. The use of this additional switch allows the same function to be achieved as that described in conjunction with FIG. 12.

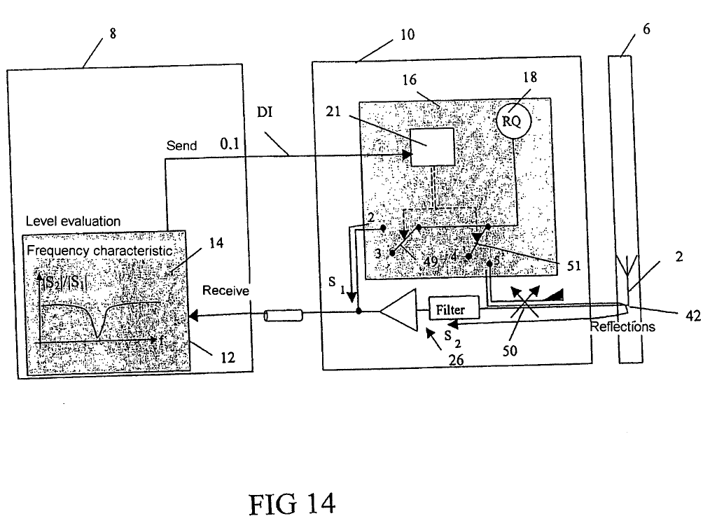

As a result of the use of this additional switch 51, it is now also possible to dispense with the RF switch 20. The resulting circuit is illustrated in FIG. 14. In this embodiment, the RF switch 20 is no longer required to switch off the noise source 18, since it can now be switched off by a combination of the switch positions 3 and 4.

The advantages which are achieved by the invention are, in particular, that it is possible to use a noise generator 18 which can be integrated in the antenna module 10 as a transmitter. The tuner or transceiver, which has being switched to a diagnosis mode, can be used as the receiver 8. This results in a particularly low-cost transmitter. Since the receiver 8 already exists, software can be added to it for the diagnosis function.

As a further alternative embodiment of the invention, an additional antenna can be provided which, in contrast to the antenna 2, is not connected to the receiver module 8. The noise signal S is now injected into this additional antenna from the noise generator 18. The additional antenna then transmits this noise signal to the antenna or antennas 2. The respective received signal S′ or S2 which results from this is received and evaluated by the test module 12 in the receiver module 8.

As described above, the present invention discloses the use of a very simple low-cost test signal source for antenna diagnosis. This is achieved by using an economically advantageous low-price noise signal source whose power need not be known. The noise source is suitable for testing antennas in a number of frequency bands, for example AM, FM, TV, owing to its wide signal spectrum. The sequential use of a different antenna in each case as the transmitting antenna makes it possible to produce a transmission matrix which represents the near-field coupling between different antenna combinations. The signal power of the noise source or test signal source can be calibrated out by means of this transmission matrix. Accordingly, it is possible to use a simple, low-cost test signal source whose level, in contrast to all previous approaches, need not be known and need not be reproducible. The transmission matrix is additionally used to calculate out external influences which affect all or two or more of the antennas, such as an ice, snow or fallen-leaf coating on them all, as well as external interference signals. A directional coupler in a calibration circuit is used for an arrangement for single antenna systems. In this case, the reception level is measured for each of two or more switch positions in the arrangement at the tuner. The power of the low-price signal source can be determined and calibrated out from different level values. This calibration circuit may, of course, also be used for two or more antennas.

In summary, the present invention discloses a method for testing at least one antenna 2 having a receiver module 8 and a coupling module 16 which is arranged between the antenna 2 and the receiver module 8. In this case, the antenna 2 and the receiver module 8 are supplied with a noise signal S as a test signal, by means of the coupling module 16. An instantaneous transmission coefficient is then determined by means of a test module 12 on the basis of a superimposition of the noise signal S, S1 with a received signal S′, S2 which results from the noise signal, S, S1, and is compared with a reference transmission coefficient which is stored in a transmission matrix. Furthermore, an arrangement is likewise disclosed for carrying out the method according to the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-22. (canceled)

23. A method for testing at least one antenna using a receiver module and a coupling module, the coupling module is arranged between the at least one antenna and the receiver module, in which the antenna and the receiver module are supplied by the coupling module with a noise signal from at least one noise signal source as a test signal, the method comprising the acts of:
determining an instantaneous transmission coefficient which indicates the ratio between a first and second noise signal, the first noise signal is passed to the test module via a first path without passing through the at least one antenna, and the second noise signal is passed to the test module from the noise source via a second path which passes via the at least one antenna; and
comparing the instantaneous transmission coefficient with a reference transmission coefficient, which is stored in a transmission matrix, by a test module.

24. The method as claimed in claim 23, wherein the at least one noise source is an uncalibrated noise source.

25. The method as claimed in claim 24, wherein switching takes place between the first path and the second path using a switchable coupling circuit which injects the noise signal into the first and second paths respectively, such that the noise signal is passed directly to the receiver via the first path, while a noise signal which has been reflected from the at least one antenna is superimposed on the noise signal and is passed to the receiver via the second path, and the second noise signal is detected on the basis of the transmission matrix, and is compared with the frequency characteristic of the first noise signal.

26. The method as claimed in claim 24, wherein a switchable coupling circuit, which injects the noise signal into the first and second paths, and in which the noise signal which is reflected at the at least one antenna has the noise signal superimposed on it on an impedance, switches between the first path and the second path such that the noise signal is passed directly to the receiver via the first path, while a noise signal which has been reflected from the at least one antenna is superimposed on the noise signal and is passed to the receiver via the second path, and the second noise signal is detected on the basis of the transmission matrix, and is compared with the frequency characteristic of the first noise signal.

27. The method as claimed in claim 24, wherein a directional coupling network with a switchable signal flow direction, which injects the noise signal into the first path or second path, switches between the first path and the second path such that the noise signal from the noise source is made available as the first noise signal, and the noise signal, which is being reflected on the antenna is made available as the second noise signal, for evaluation at the receiver.

28. The method as claimed in claim 27, wherein the switching between the first path and the second path is carried out using an additional switching device in the first path and a switchable amplifier in the second path, instead of being carried out at the inputs of the directional coupling network.

29. The method as claimed in claim 23, wherein a calibrated noise source whose frequency characteristic is known is used as the at least one noise source, a superimposition of the first and second noise signals is supplied to the test module and is in the form of a typical frequency characteristic, and the typical frequency characteristic is compared with the known frequency characteristic of the calibrated noise source.

30. The method as claimed in claim 23, wherein an additional antenna which has no connection for the receiver module and into which the noise signal is injected, sends this noise signal as a test signal to the at least one antenna.

31. The method as claimed in claim 23, wherein the at least one antenna is part of a multiple antenna system which has two or more antennas, and a noise signal which been reflected at each of the individual antennas, and/or a noise signal which has been transmitted between the antennas are/is evaluated as the second noise signal.

32. The method as claimed in claim 23, wherein the transmission coefficient and the reference transmission coefficient are determined by a frequency analysis and/or level analysis.

33. An arrangement for testing at least one antenna, the arrangement comprising:
a receiver module;
a coupling module which is arranged between the at least one antenna and the receiver module, wherein the coupling module injects a noise signal from at least one noise source into the at least one antenna and into the receiver module; and
a test module which determines an instantaneous transmission coefficient, which indicates the ratio between a first and second noise signal, the first noise signal is passed to the test module via a first path without passing through the at least one antenna, and the second noise signal is passed to the test module from the noise source via a second path which passes via the at least one antenna, and which compares the instantaneous transmission coefficient with a reference transmission coefficient which is stored in a transmission matrix.

34. The arrangement as claimed in claim 33, wherein the at least one noise source is an uncalibrated noise source.

35. The arrangement as claimed in claim 34, further comprising:
a switchable coupling circuit which injects the noise signal into the first and/or second path, which switches between the first path and the second path, such that noise signal can be supplied directly to the receiver via the first path while the noise signal which is being reflected from the at least one antenna and is superimposed on the noise signal can be supplied to the receiver via the second path, the test module detecting the second noise signal on the basis of the transmission matrix, and comparing it with the frequency characteristic of the first noise signal.

36. The arrangement as claimed in claim 34, further comprising:
a switchable coupling circuit which injects the noise signal into the first or second path and in which the noise signal which has been reflected at the at least one antenna can be superimposed on the noise signal in an impedance, which switches between the noise signal is supplied directly to the receiver via the first path while the noise signal which is being reflected from the at least one antenna and is superimposed on the noise signal is supplied to the receiver via the second path, the test module detecting the second noise signal on the basis of the transmission matrix, and comparing it with the frequency characteristic of the first noise signal.

37. The arrangement as claimed in claim 34, further comprising:
a directional coupling network with a switchable signal flow direction, which injects the noise signal into the first or second path, which switches between the first path and the second path, such that the noise signal from the noise source is made available as the first noise signal, and the noise signal, which is being reflected on the antenna is made available as the second noise signal, for evaluation at the test module.

38. The arrangement as claimed in claim 37, wherein an additional switching device is in the first path and a switchable amplifier is in the second path, by means of which it is possible to switch between the first path and the second path instead of to the inputs of the directional coupling network.

39. The arrangement as claimed in claim 33, wherein the at least one noise source is a calibrated noise source whose frequency characteristic is known.

40. The arrangement as claimed in claim 39, wherein the noise signal can be injected by a coupling network into the path from the at least one antenna to the test module, such that the first and the second noise signal are superimposed, with the superimposition resulting in a typical frequency characteristic, and in which the test module compares the typical frequency characteristic with the known frequency characteristic of the calibrated noise source.

41. The arrangement as claimed in claim 39, wherein the noise signal is injected by a directional coupling circuit into the path from the at least one antenna to the test module, such that only the second noise signal is detected, and the test module compares the typical frequency characteristic resulting from the second noise signal with the known frequency characteristic of the calibrated noise source.

42. The arrangement as claimed in claim 33, further comprising:
an additional antenna which has no connection for the receiver module, which sends the noise signal as a test signal to the at least one antenna, with the coupling module injecting the noise signal into the additional antenna.

43. The arrangement as claimed in of claims 33, wherein the coupling module has at least one RF switch for connection of the at least one antenna.

44. The arrangement as claimed in claim 33, wherein the transmission matrix in the case of a multiple antenna system, comprises a number of transmitting antennas and receiving antennas as antenna pairs which correspond to the number of antennas.
